(19) United States
(12) Patent Application Publication
(10) Pub. No.: US 2007/0147029 A1
(43) Pub. Date: Jun. 28, 2007

(54) Water sealing structure of a lamp

(76) Inventor: Jen--Yen Yen, Yenpu Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/318,878

(22) Filed: Dec. 28, 2005

(51) Int. Cl. F21L 13/00

(52) U.S. Cl. 362/192

(57) ABSTRACT

A water sealing structure used in a lamp using a crank handle-operated dynamo to generate electricity is disclosed to have a flexible rubber packing strip fastened to the housing of the lamp to seal the gap between top and bottom cover shells of the housing, a flexible rubber covering affixed to the housing and covered on a lampshade at the housing to seal the gap between the lampshade and the housing, a flexible rubber button covered on the power switch of the lamp to seal the gap between the power switch and the top cover shell of the housing, and a water sealing cap fastened to the bottom cover shell of the housing around the crank handle to seal the gap between the crank handle and the bottom cover shell.

### BACKGROUND OF THE INVENTION

1. Field of the Invention

The present invention relates to lamps and more particularly, to a water sealing structure used in a lamp that uses a crank handle-operated dynamo to generate electricity.

2. Description of the Related Art

There are known hand lamps that use a crank handle-operated dynamo to generate electricity for charging a rechargeable battery that provides the necessary working voltage to the bulb(s). These conventional hand lamps are not suitable for use outdoors during raining because rainwater may penetrate gaps in external lamp parts to wet the internal circuit and to cause a short circuit.

### SUMMARY OF THE INVENTION

The present invention has been accomplished under the circumstances in view. It is the main object of the present invention to provide a water sealing structure for lamp, which effectively seals the lamp against outside water. According to the present invention, the water sealing structure is used in a lamp that uses a crank handle-operated dynamo to generate electricity for charging a rechargeable battery. The water sealing structure comprises a flexible rubber packing strip fastened to the housing of the lamp to seal the gap between top and bottom cover shells of the housing, a flexible rubber covering affixed to the housing and covered on a lampshade at the housing to seal the gap between the lampshade and the housing, a flexible rubber button covered on the power switch of the lamp to seal the gap between the power switch and the top cover shell of the housing; and a water sealing cap fastened to the bottom cover shell of the housing around the crank handle to seal the gap between the crank handle and the bottom cover shell.

### BRIEF DESCRIPTION OF THE DRAWINGS

FIG. 1 is an exploded view of a lamp according to the present invention.

FIG. 2 is a sectional view of the lamp according to the present invention.

### DETAILED DESCRIPTION OF THE PREFERRED EMBODIMENT

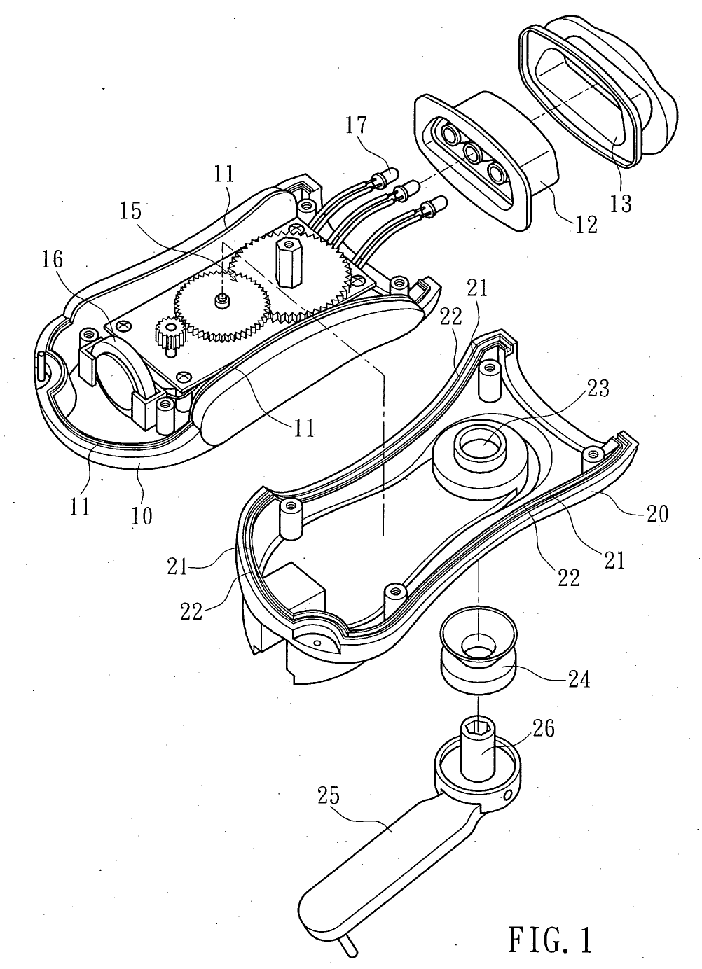

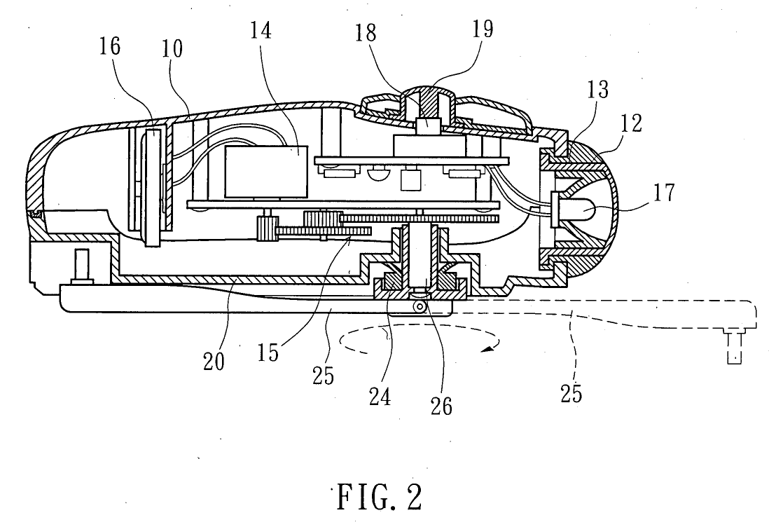

Referring to FIGS. 1 and 2, a lamp in accordance with the present invention is shown comprising a bottom cover shell 20, and a top cover shell 10 covering the bottom cover shell 20. The bottom cover shell 20 has a top coupling groove 21 extending along the border thereof. The top cover shell 10 has a bottom coupling flange 11 extending along the border thereof and engaged into the top coupling groove 21 of the bottom cover shell 20. Further, a flexible rubber packing strip 22 is affixed to the top coupling groove 21 to support the bottom coupling flange 11 of the top cover shell 10 in the top coupling groove 21 of the bottom cover shell 20 and to seal the gap between the top cover shell 10 and the bottom cover shell 20.

The lamp further comprises a dynamo 14, a rechargeable battery 16, a set of LEDs (light emitting diodes) 17 and a power switch 18. The dynamo 14, the rechargeable battery 16, the set of LEDs (light emitting diodes) 17 and the power switch 18 are mounted inside the top cover shell 10 and electrically coupled together. A transmission gear train 15 is mounted in the top cover shell 10 and coupled to the input shaft (not shown) of the dynamo 14. The bottom cover shell 20 has an axle hole 23. A crank handle 25 is pivotally mounted in the axle hole 23 of the bottom cover shell 20 and extending out of the bottom cover shell 20 for operation by the user to rotate the transmission gear train 15 and to further drive the dynamo to generate electricity to charge the rechargeable battery 16. The crank handle 25 has a driving shaft 26 coupled to the transmission gear train 15. A water sealing cap 24 is fastened to the axle hole 23 around the driving shaft 26 of the crank handle 25 to seal the gap between the bottom cover shell 20 and the crank handle 25.

A flexible rubber button 19 is mounted in the top cover shell 10 and covered on the power switch 18 outside the top cover shell 10 to seal the gap between the power switch 18 and the top cover shell 10. The user can press the flexible rubber button 19 to switch on/off the power switch 18 and to further turn on/off the LEDs 17.

Further, a lampshade 12 is fastened to the top cover shell 10 and the bottom cover shell 20 at one side corresponding to the LEDs 17. A flexible rubber covering 13 is fastened to the top cover shell 10 and the bottom cover shell 20 to seal the gap between the cover shells 10 and 20 and the lampshade 12.

Although a particular embodiment of the invention has been described in detail for purposes of illustration, various modifications and enhancements may be made without departing from the spirit and scope of the invention.

What the invention claimed is:

1. A water sealing structure used in a lamp, sad lamp comprising:
a housing, said housing comprising a bottom cover shell and a top cover shell covering said bottom cover shell, said bottom cover shell having an axle hole;
at least one light emitting diode installed in said top cover shell;
a rechargeable battery mounted inside said top cover shell and electrically coupled to said at least one light emitting diode;
a power switch mounted in said top cover shell and adapted to control electric connection between said at least one light emitting diode and said rechargeable battery;
a lampshade fastened to said housing at one side and covering said at least one light emitting diode;
a dynamo mounted inside said top cover shell and adapted to generate electricity and to charge said rechargeable battery;
a transmission gear train mounted inside said top cover shell and coupled to an input shaft of said dynamo; and
a crank handle pivotally mounted in said axle hole for operation by the user to rotate said transmission gear train and to further drive said dynamo to generate electricity;
the water sealing structure comprising:
a flexible rubber packing strip mounted in between said top cover shell and said bottom cover shell to seal the gap between said top cover shell and said bottom cover shell;
a flexible rubber button coupled to the top cover shell and covered on said power switch to seal the gap between said power switch and said top cover shell;
a flexible rubber covering affixed to said top cover shell and said bottom cover shell and covered on said lampshade to seal the gap between said lampshade and said top and bottom cover shells; and
a water sealing cap fastened to said axle hole of said bottom cover shell around said crank handle to seal the gap between said crank handle and said bottom cover shell.
